(19) United States
(12) Patent Application Publication
(10) Pub. No.: US 2025/0076095 A1
(43) Pub. Date: Mar. 6, 2025

(54) DOSING APPARATUS

(71) Applicant: Herbert Saier GmbH, Gundelfingen (DE)

(72) Inventor: Michael SAIER, Freiburg/Kappel (DE)

(21) Appl. No.: 18/679,935

(22) Filed: May 31, 2024

(30) Foreign Application Priority Data
Sep. 4, 2023 (DE) 10 2023 123 774.8

(51) Int. Cl. G01F 11/44; A47L 15/44; D06F 39/02; D06F 105/42

(52) U.S. Cl. CPC G01F 11/44; A47L 15/4418; A47L 15/449; D06F 39/022; A47L 2501/07; D06F 2105/42

(57) ABSTRACT

A metering device for metering and supplying media via fluid lines to a plurality of target devices, wherein the metering device includes an entry disc having a plurality of entry-side connections which can each be connected to a container, and an actuator which is displaceable relative to the entry disc and includes a plurality of through-channels. Each through-channel can be connected to a target device, wherein due to a displacement of the actuator relative to the entry disc, in each case at least one of the through-channels can be brought into communicative connection with one of the connections. The metering device includes a plurality of pumps which can be activated by a controller of the metering device and which are configured for removing medium from the container and for conveying it to the target device. Each through-channel is associated with a pump that is arranged downstream of the through-channel.

The invention relates to a metering device according to claim 1.

The invention focuses on metering devices by means of which in particular different media can be removed from different containers and conveyed to different target devices. A metering device of this kind can select the corresponding medium, according to the requirements of the target device, and supply it to the desired target device in the desired volume, i.e. the desired amount.

A metering device which comprises a branch point is disclosed by DE 10 2015 110 862 A1, which originates from the applicant.

The metering device allows for conveying to different target devices.

WO 2013/075962 A1, which likewise originates from the applicant, discloses a mixing distributor.

This can comprise, in a geometrically inverted arrangement, one entry and a plurality of outlets. Thus, only one medium can be conveyed to a plurality of target devices. The document furthermore discloses a series connection of two mixing distributors. Thus, a plurality of media can be conveyed to a plurality of target devices.

Proceeding from the last-described prior art, the object of the invention is that of specifying a metering device by means of which a reliable mode of operation is ensured, with a structurally simple design.

The invention achieves this object by the features of claim 1.

The principle of the invention essentially consists in arranging a unit on the metering device which comprises an entry disc and an actuator that is displaceable relative thereto.

The entry disc and the actuator can in particular both consist of ceramic material.

A plurality of entry-side connections is arranged on the entry disc, which connections are in each case connected to a container. In one embodiment of the invention, the entry disc comprises eight entry-side connections for media, in particular for different media. In this case, for example seven product media and one rinsing medium can be provided.

The invention denotes every type of chemical or chemical component, as can typically be used in washing or cleaning processes, but also in disinfection processes or sterilization processes, as a product medium.

The number of entry-side connections is, however, arbitrary. The number of eight entry-side connections is to be understood merely by way of example.

The entry disc can in particular be configured as a circular disc or substantially in the manner of a circular disc.

The actuator can also be formed of a discoid body.

The actuator and entry disc can be arranged concentrically with respect to one another.

Advantageously, the entry side of the actuator is preloaded on the outlet side of the entry disc and contacts it.

The actuator can be arranged so as to be rotatable relative to the entry disc, and specifically advantageously so as to be rotatable about a central longitudinal axis of the entry disc. The actuator can be activated and rotatably driven by a drive, for example by an electric motor. For this purpose, the actuator can for example be provided with a gearwheel on its outer periphery, which can be activated by a pinion of a motor.

According to the invention, the actuator comprises two or more through-channels.

In a first variant, the actuator comprises two through-channels.

In a second variant, the actuator comprises three through-channels.

The number of through-channels corresponds in particular to the number of target devices connected to the metering device.

The through-channels are each connected, at the outlet side, to a target device.

The target device can in particular be provided by a washing machine. Other types of target devices, for example dishwashers, are covered by the invention. In particular, all types of washing or cleaning devices, washing or cleaning systems, or washing or cleaning machines are possible as the target device.

A pump is arranged downstream of each through-channel.

For the event that the actuator comprises two through-channels, accordingly two pumps are provided.

For the event that three through-channels are arranged in the actuator, three pumps are provided.

The pumps can in particular be formed by hose pumps, as are described in particular in the patent applications by the applicant, described at the outset and set out below.

Reference is made thereto, in order to avoid repetitions.

On account of a request for a medium in a particular amount from a first target device, a controller of the metering device can activate a motorized drive of the actuator and displace the actuator into a first position.

In this first position, the first through-channel that is associated with the first target device establishes a communicative connection to the container in which the requested medium is located.

In this case, the arrangement and geometry of the entry-side connections on the entry disc, and the positioning and geometry of the through-channels, is such that when the first through-channel has reached a desired rotational range position, and has been brought into communicative contact with the desired entry-side connection, said through-channel does not have any communicative connection to another through-channel.

Thus, in this position of the actuator, the through-channel is configured and positioned so as to be fluid-tight with respect to all the other through-channels.

The first pump that is associated with the first through-channel can now be activated and operated by the controller, and can remove the first medium from the container, in the desired amount, and supply it to the first target device.

The operation of the first pump makes it possible for only the requested medium to be conveyed.

No other medium is conveyed by the operation of the pump. In particular, no suction effect in another through-channel is generated as a result of operation of the first pump.

In the first position of the actuator, i.e. when the first through-channel is located in a product position, the second through-channel can assume a rinsing position or a parked position, optionally also another product position.

A product position of a through-channel denotes a position in which the through-channel communicates with a product connection, i.e. with a connection conveying a product medium.

A rinsing position of a through-channel is understood to mean a position of the through-channel in which the through-channel communicates with a rinsing medium-conveying inlet in the entry disc.

A parked position of a through-channel denotes a position in which the through-channel rests on a blocking surface arranged on the entry disc. The blocking surface can close the through-channel.

In the first position of the actuator, the first through-channel assumes a first product position.

In this position of the actuator, the second through-channel also assumes a defined position, specifically either a rinsing position or a parked position, or a different product position.

The first pump can now be activated by the controller and can convey the desired medium, without influencing the remaining communication paths.

As a result, a high degree of operating reliability is achieved.

It should be noted that the first through-channel and the second through-channel can in each case be configured in the manner of a drilled hole, which completely crosses the actuator, and specifically in parallel with a central axis of the actuator.

The plurality of through-channels are in particular formed in parallel with one another.

It is furthermore noted that the plurality of through-channels assume a fixed rotational range position relative to one another.

On account of a rotation of the actuator about a particular angle, all the through-channels are rotated together about the same angle.

The applicant is the proprietor of a series of patent applications which describe metering devices of the prior art. In order to avoid repetition, we hereby refer to the known metering devices by the applicant, which are disclosed in the German patent applications DE 10 2011 108 396 A1, DE 10 2011 119 021 A1, DE 10 2012 012 913 A1, DE 10 2014 002 560 A1, DE 10 2014 010 126 A1, DE 10 2015 110 862 A1, DE 10 2015 107 105 A1, DE 10 2015 170 976 A1, DE 10 2016 102 829 A1, DE 10 2017 114 767 A1, DE 10 2017 103 168 A1, DE 10 2017 114 665 A1, and DE 10 2018 113 644 A1.

The content of these patent applications is hereby included in the content of the present patent application, specifically for the purpose of improved understanding of the technical teaching described in the present patent application, and also for the purpose of, if necessary, also incorporating individual features or combinations of features from the cited patent applications to which reference is made, in the content of the present patent application, and also in the content of the claims of the present patent application.

It is noted that, within the meaning of the present invention, the metering device described in the present patent application can be combined with any features of the metering devices known from these patent applications, unless technical inconsistencies result from this. All these conceivable and possible combinations of features are explicitly included by the invention according to the present patent application.

According to an advantageous embodiment of the invention, the metering device allows operation of a pump only when the actuator assumes a position in which a communicative connection of the through-channel associated with said pump to any other through-channel is blocked.

According to this embodiment of the invention, a particularly reliable mode of operation is made possible. If the first pump on the outlet side of the first passage signal generates a suction pressure, then only the medium to be conveyed is exposed to said suction pressure.

In this embodiment, suctioning of an undesired medium or impairment of another communication path is excluded. In particular in the event that the first pump is driven, in order to convey rinsing medium, it is ensured that, in this position of the actuator, no other through-channel communicates with a rinsing agent inlet.

Thus, in this embodiment of the invention too, it is ensured that, in the event that the first through-channel assumes a product position, the second through-channel or all remaining through-channels each assume a product position or a rinsing position or a parked position.

Since all the through-channels assume defined positions, it is ensured that the communication path, which is a component of the first through-channel is separated and isolated in a fluid-tight manner from all the remaining switched communication paths.

The same applies if the first through-channel does not assume a product position but rather a rinsing position. Then, in this position of the actuator, it is ensured that all the remaining through-channels are arranged either on a product position or on a parked position.

Only in the event that the entry disc provides different rinsing agent inlets that are communicatively separated from one another can a plurality of through-channels simultaneously assume a rinsing position and be connected to the separates rinsing agent inlets.

According to an advantageous embodiment of the invention, two pumps for conveying media can be operated simultaneously using the metering device. According to this embodiment of the invention, a particularly efficient mode of operation of the metering device can be achieved.

Thus, conveying of a first medium to the target device and simultaneously conveying of a second medium to the second target device can be carried out simultaneously.

According to an advantageous embodiment of the invention, a flow is possible through the plurality of through-channels, along the same direction.

This embodiment of the invention makes it possible to provide particularly simple connection possibilities. All the entry nozzles for the entry-side connections can in particular be arranged on the entry side of the entry disc, and all the entry nozzles for the outlet-side connections can be arranged on the outlet side of the actuator.

Thus, all media flow through the metering device exclusively from the entry side of the entry disc to the outlet side of the entry disc.

According to an advantageous embodiment of the invention, the plurality of through-channels are in each case configured to be straight. This embodiment of the invention allows for a particularly reliable mode of operation since no dead spaces occur in which accumulations of material can form.

According to an advantageous embodiment of the invention, each through-channel can assume at least a product position, in which it communicates with a product medium-guiding entry connection. This embodiment of the invention offers the possibility that each of the through-channels can assume a product position.

This enables an efficient mode of operation.

For clarification, it is noted that the term medium within the meaning of the present patent application includes every type of conveyable fluid, for example chemicals, but also rinsing media.

In contrast to the rinsing medium, a product medium is understood to mean only those substances, i.e. chemicals, which are used in washing or cleaning processes.

According to an advantageous embodiment of the invention, each through-channel can assume at least a rinsing position, in which it communicates with a rinsing medium-guiding entry connection. According to this embodiment of the invention, it is possible that, after each time product medium is conveyed through a through-channel, the through-channel can be rinsed with rinsing medium.

According to an advantageous embodiment of the invention, each through-channel can assume at least a parked position, in which it neither communicates with a rinsing medium-guiding entry connection nor communicates with a medium-guiding entry connection. This embodiment of the invention allows for a particularly reliable mode of operation.

If a first through-channel is not required, and product medium or rinsing medium is intended to be conveyed through a second through-channel at a particular point in time, the first through-channel, which is not required, can be moved into a parked position and completely closed in said position.

An undesired impairment during operation of the pump is thus excluded.

According to an advantageous embodiment of the invention, the through-channel that assumes a parked position is closed by an entry disc-side blocking surface.

This embodiment of the invention offers the possibility of a particularly simple structure.

According to an advantageous embodiment of the invention, an arrangement of the through-channels relative to one another in the actuator, and an arrangement of the entry-side connections on the entry disc is made such that in each position of the actuator relative to the entry disc in each case only at most one through-channel assumes a product position.

This embodiment of the invention offers a particularly reliable mode of operation.

According to an advantageous embodiment of the invention, an arrangement of the through-channels relative to one another in the actuator, and an arrangement of the entry-side connections in the entry disc is made such that in at least one position of the actuator relative to the entry disc two through-channels assume a product position.

This embodiment of the invention allows for a particularly quick conveying of media and simultaneous operation of a plurality of pumps.

According to an advantageous embodiment of the invention, at least one entry-side connection is configured as a rinsing medium connection. This embodiment of the invention allows for regular rinsing of the through-channels in a simple manner. In particular it can be provided, according to the invention, that after each time a product medium is conveyed, the through-channel is rinsed using a rinsing medium.

Therefore, the rinsing medium connection can particularly advantageously be configured such that a through-channel reaches a rinsing position, starting from a product position and by means of a relative rotation in any direction of rotation before it reaches a further product position following a further rotation.

According to an advantageous embodiment of the invention, the controller of the metering device performs a metering process after receiving a request signal from at least one of the target devices, and for this purpose performs a removal of a predetermined volume of medium from the container and conveying of said volume towards a target device, with the aid of at least one of the pumps.

This embodiment of the invention allows for a particularly reliable mode of operation of the metering device.

According to an advantageous embodiment of the invention, in each case an entry-side connection is connected to a container. This embodiment of the invention allows for recourse to conventional designs of metering devices.

According to an advantageous embodiment of the invention, a plurality of containers is provided, which containers are filled with different media.

This embodiment of the invention allows for particularly efficient operation of a plurality of target devices.

According to an advantageous embodiment of the invention, the entry-side connections comprise seven product medium connections and one rinsing medium connection.

This embodiment of the invention makes it possible to cover a wide spectrum of different intended uses of a metering device according to the invention.

According to an advantageous embodiment of the invention, the entry-side connections comprise outlet openings that are arranged on an outlet side of the entry disc. This embodiment of the invention allows for a particularly simple structure.

According to an advantageous embodiment of the invention, the outlet openings are arranged so as to be equidistant from one another. This embodiment of the invention allows for a particularly simple structure and a simple mode of operation, as well as simple control.

According to an advantageous embodiment of the invention, the outlet openings are bordered by material regions of the entry disc.

According to a further advantageous embodiment of the invention, the material regions provide blocking surfaces by means of which a through-channel can be closed.

This embodiment of the invention allows for a particularly simple arrangement of blocking surfaces.

According to an advantageous embodiment of the invention, blocking surfaces are arranged adjacently to a plurality or all of the outlet openings on both sides.

This embodiment of the invention allows for a particularly simple structure and a reliable mode of operation.

According to an advantageous embodiment of the invention, the material regions are of a width that is at least slightly larger than an inside diameter of an entry disc-side outlet of a through-channel.

This embodiment of the invention allows for a particularly simple structure and a reliable mode of operation.

According to an advantageous embodiment of the invention, the actuator comprises two through-channels. This embodiment of the invention makes it possible to convey different media to two target devices.

According to an advantageous embodiment of the invention, the two through-channels together enclose an angle between 90° and 140°, in particular an angle of approximately 112.5°.

This embodiment of the invention allows for a particularly simple structure for achieving the desired rotational range positions.

According to an advantageous embodiment of the invention, an arrangement of the two through-channels relative to one another in the actuator, and an arrangement of the entry-side connections on the entry disc is such that whenever one of the two through-channels assumes a product position, the other through-channel assumes a rinsing position.

This embodiment of the invention allows for a particularly simple structure. This embodiment of the invention also allows for a reliable mode of operation. According to an advantageous embodiment of the invention, the actuator comprises three through-channels.

This embodiment of the invention makes it possible to convey media to three target devices.

According to an advantageous embodiment of the invention, in each case two of the three through-channels together enclose an angle between 60° and 100°, in particular an angle of approximately 78.5°. This embodiment of the invention allows for a particularly simple structure.

According to an advantageous embodiment of the invention, an arrangement of the three through-channels relative to one another in the actuator, and an arrangement of the entry-side connections on the entry disc is such that whenever one of the three through-channels assumes a product position, only one of the two remaining through-channels assumes a rinsing position.

This embodiment of the invention also allows for a reliable mode of operation.

The invention furthermore relates to a method according to claim 29.

The object of the invention is that of specifying a method by means of which media can be conveyed easily to a plurality of target devices.

The invention achieves this object by the features of claim 29.

The features and advantages described above with respect to the metering device according to the invention can also be used in the same way or analogously in the method according to the invention.

Therefore, in order to avoid repetitions, reference is made to what has been stated above.

Further advantages of the metering device according to the invention and of the method according to the invention emerge on the basis of the dependent claims (not cited) and also from the following description of embodiments that are shown in the drawings,

in which:

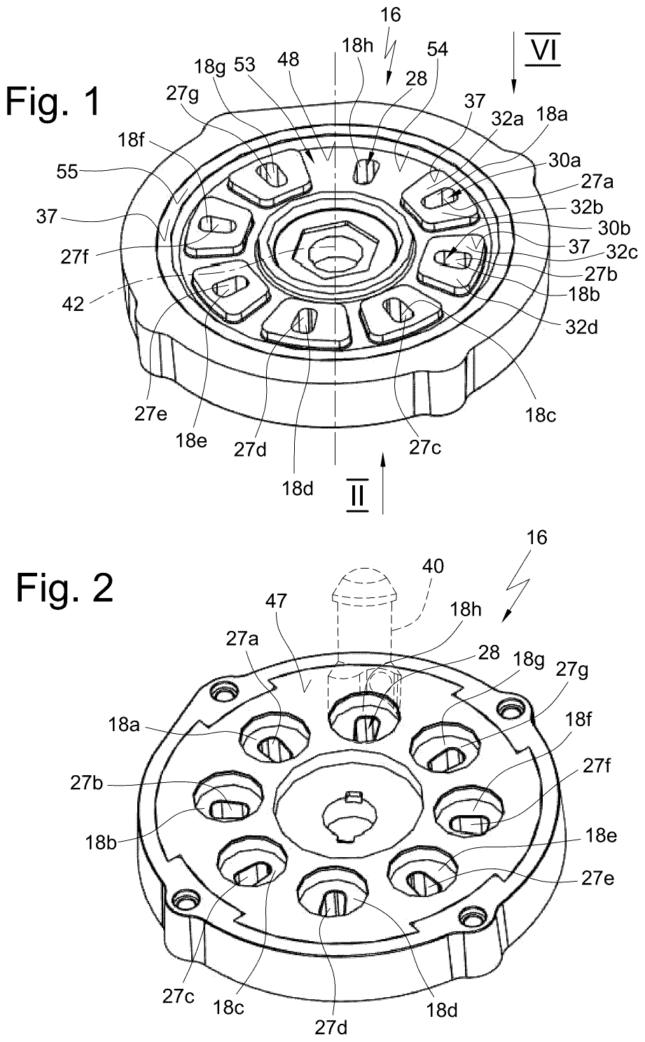

FIG. 1 is a schematic, perspective side view of an entry disc, in isolation, in a mixing distributor of a metering device according to the invention, when looking at the outlet side of the entry disc,

FIG. 2 is a rear view of the entry disc of FIG. 1 according to viewing arrow II in FIG. 1, wherein in addition, by way of example, an entry nozzle is shown in dashed lines,

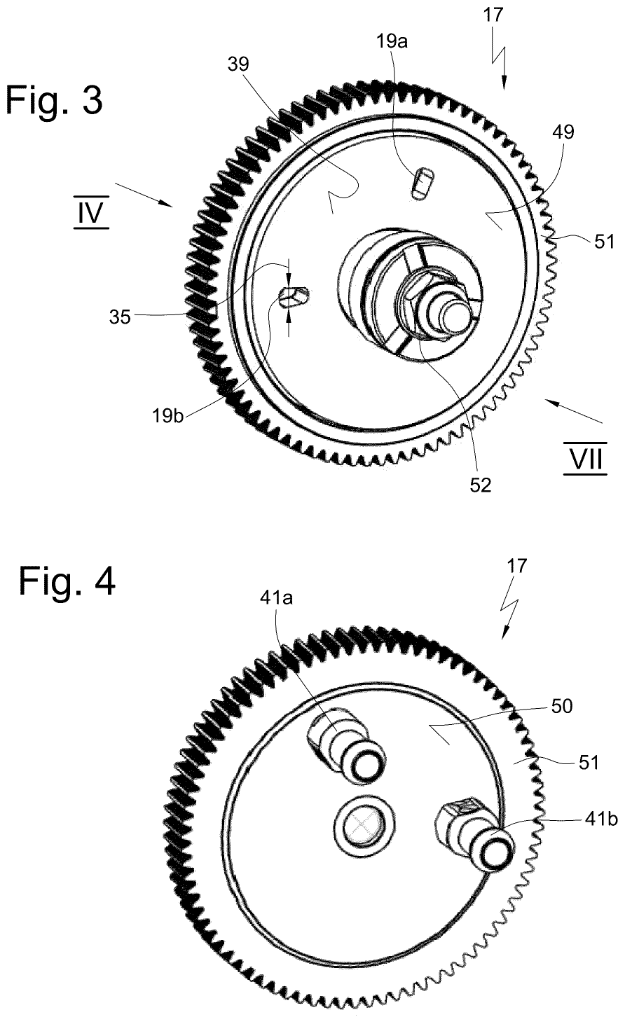

FIG. 3 is a schematic, perspective view of an actuator, in isolation, showing the entry side of the actuator, wherein the actuator comprises two through-channels,

FIG. 4 is a rear view of the actuator of FIG. 3, approximately according to the viewing arrow IV in FIG. 3,

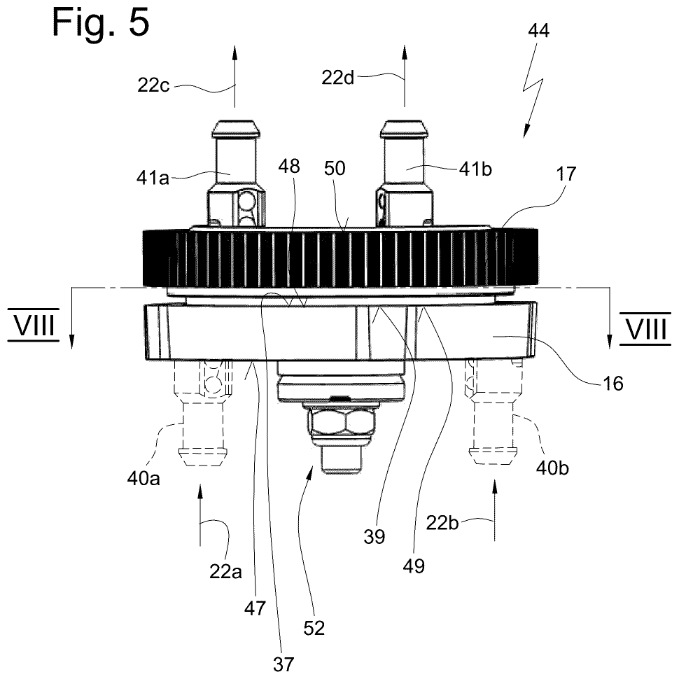

FIG. 5 is a schematic side view of a mixing distributor unit of a metering device according to the invention, comprising an entry disc and actuator, in the mounted state, with two entry nozzles shown and two outlet nozzles,

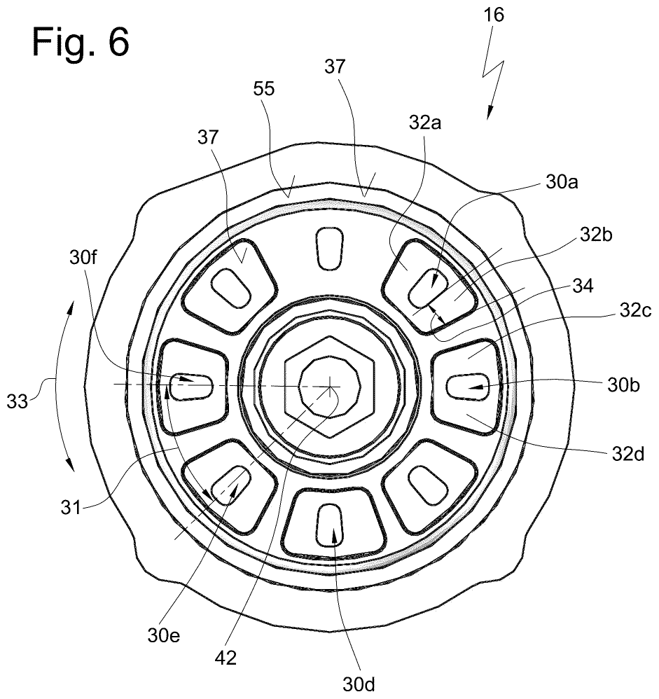

FIG. 6 is a schematic plan view of the entry disc of FIG. 1, in isolation, approximately along the viewing arrow VI in FIG. 1,

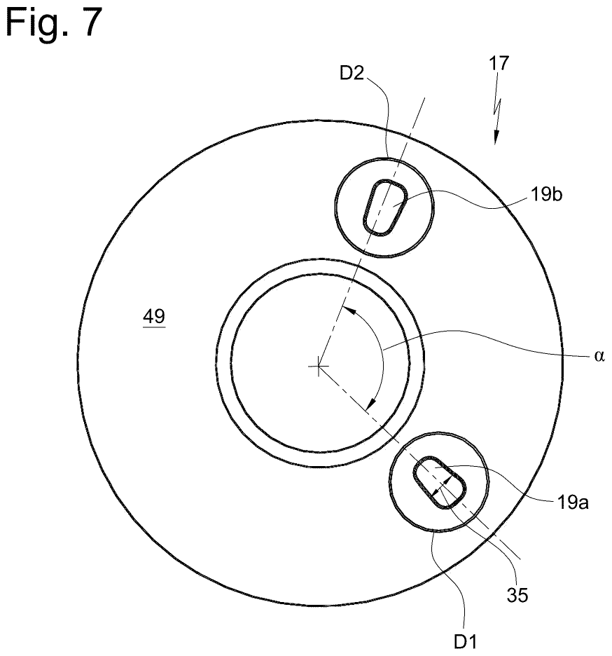

FIG. 7 is a simplified front view of the actuator of FIG. 3, without showing the gear wheel, approximately along the viewing arrow VII in FIG. 3, wherein the actuator is rotated by approximately 120° in the clockwise direction relative to the illustration in FIG. 3,

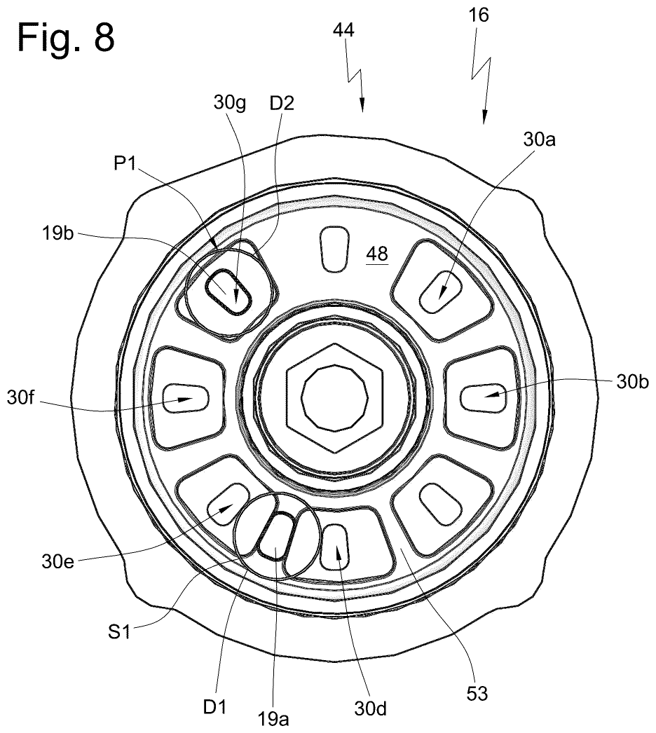

FIG. 8 is a schematic, simplified view of the mixing distributor unit of FIG. 5, with the entry disc in a view according to FIG. 6, illustrating a position of the actuator, indicating the position of the two through-channels in the actuator according to FIG. 3, wherein the illustration of FIG. 8 approximately corresponds to an imaginary, schematic, partially sectional view according to cutting line VIII-VIII in FIG. 5,

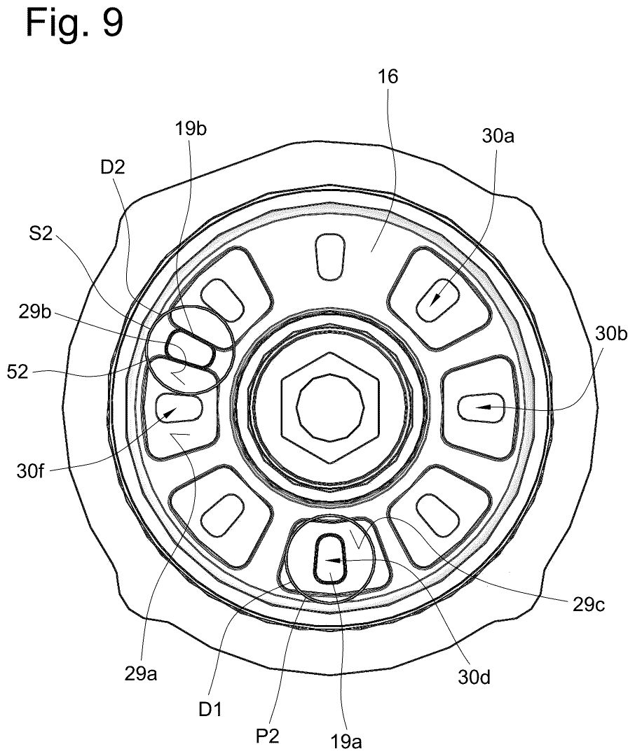

FIG. 9 shows the mixing distributor unit of FIG. 8 having a changed position of the actuator,

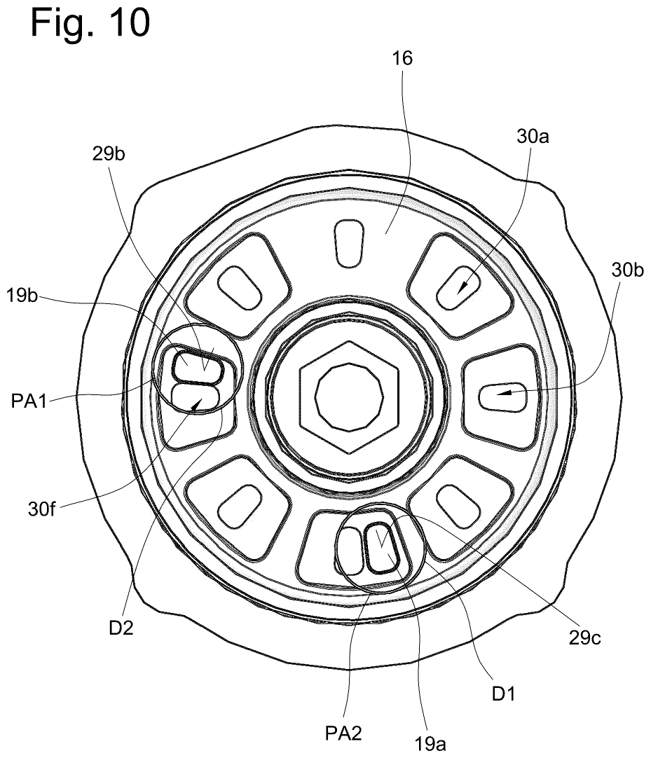

FIG. 10 shows the mixing distributor unit of FIG. 9 having a changed position of the actuator,

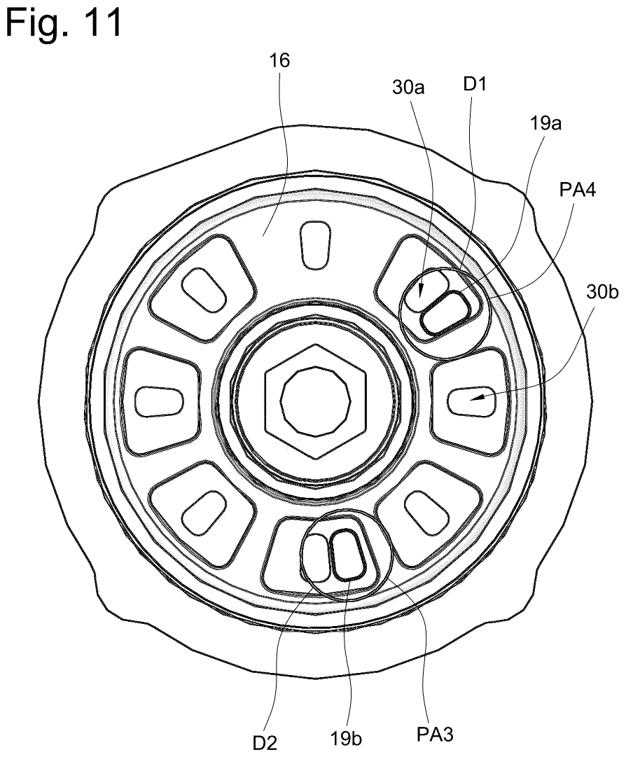

FIG. 11 shows the mixing distributor unit of FIG. 10 having a changed relative position of the actuator,

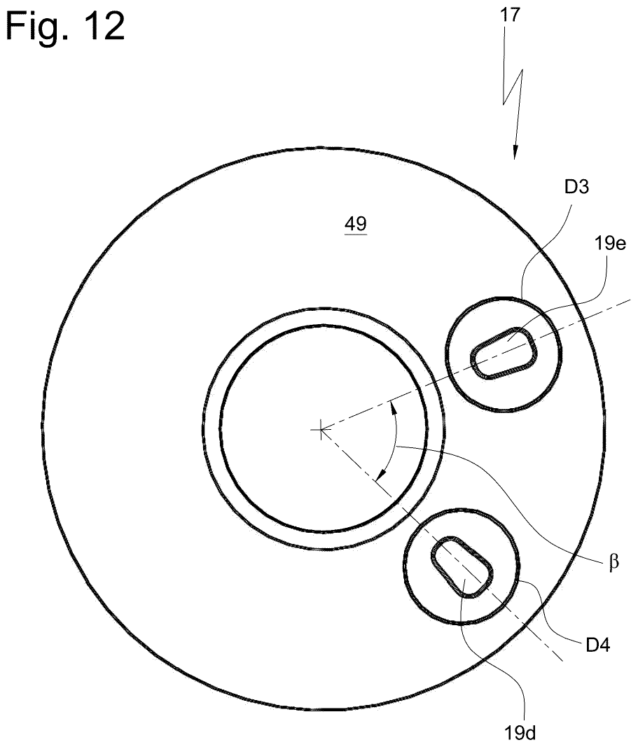

FIG. 12 shows a further embodiment of an actuator comprising two through-channels, in an illustration according to FIG. 7, wherein the angular spacing between the two through-channels is changed, relative to the embodiment of FIG. 7,

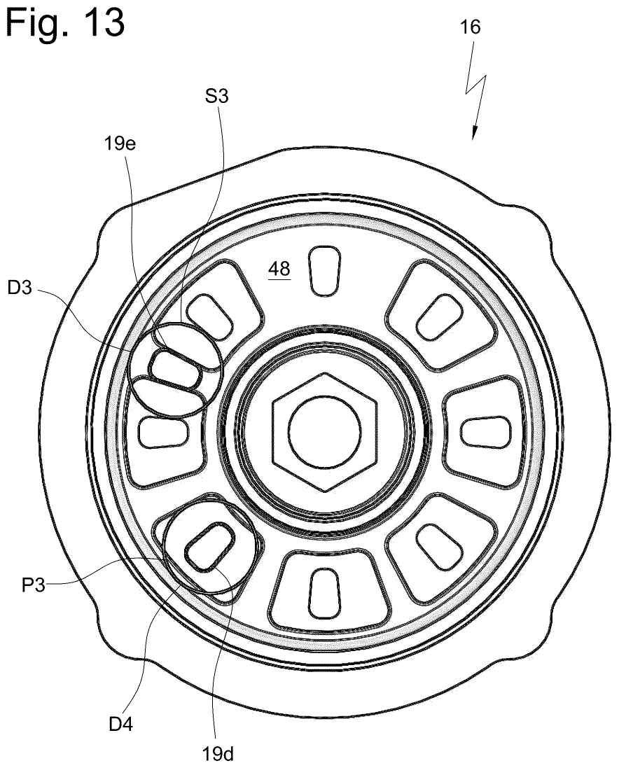

FIG. 13 shows an embodiment of a mixing distributor of a metering device according to the invention, in a view according to FIG. 8, using an actuator according to FIG. 12, in a first relative position of the actuator,

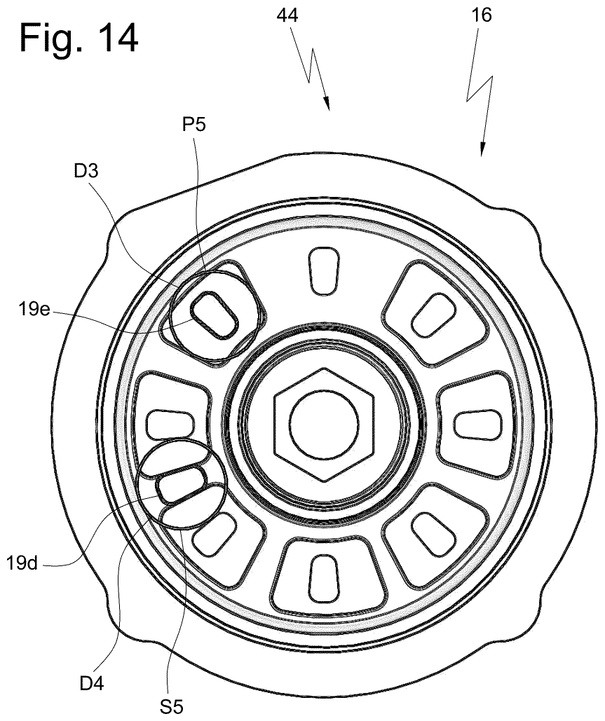

FIG. 14 shows the mixing distributor unit of FIG. 13 having a second position of the actuator,

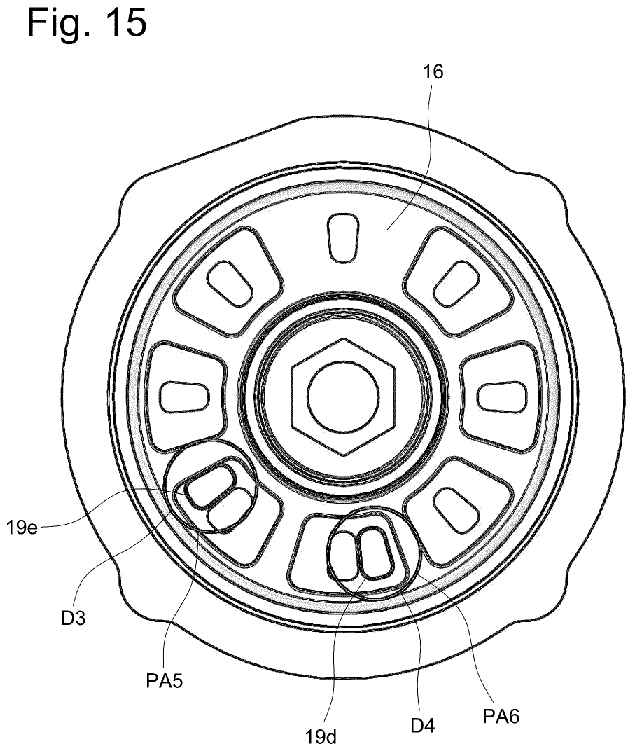

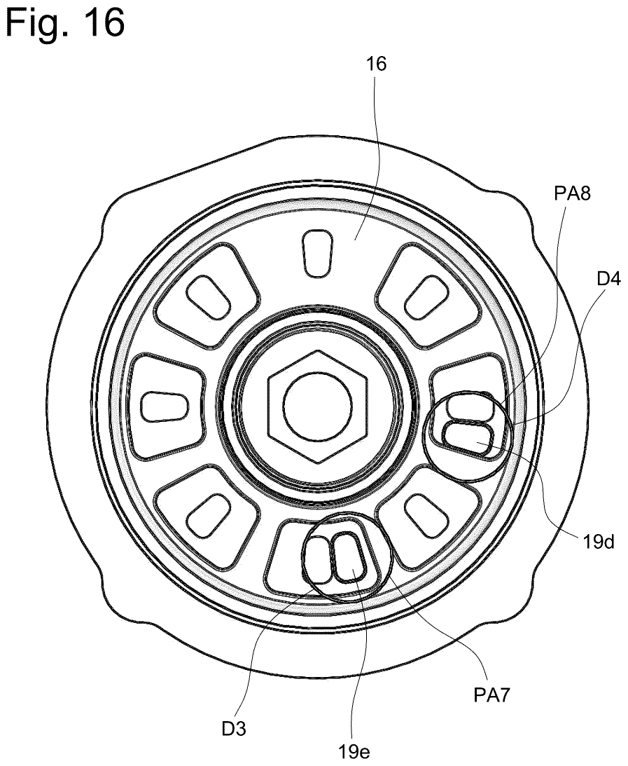

FIG. 15 shows the mixing distributor unit of FIG. 14 having a changed position of the actuator,

FIG. 16 shows the mixing distributor unit of FIG. 15 having a changed position of the actuator,

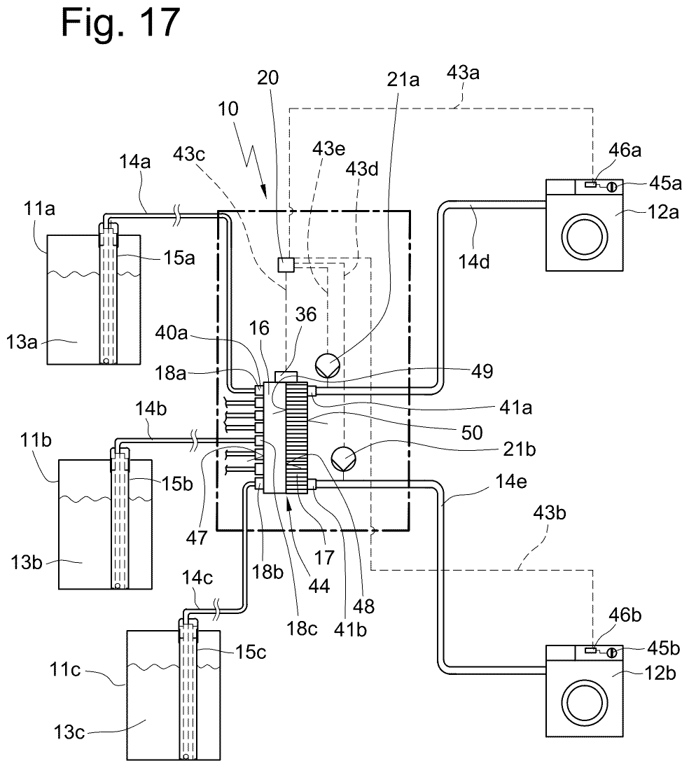

FIG. 17 is a schematic view, in the manner of a block diagram, of an embodiment of a metering device according to the invention, which comprises a mixing distributor unit explained above, and which is connected to three containers and two target devices via fluid lines,

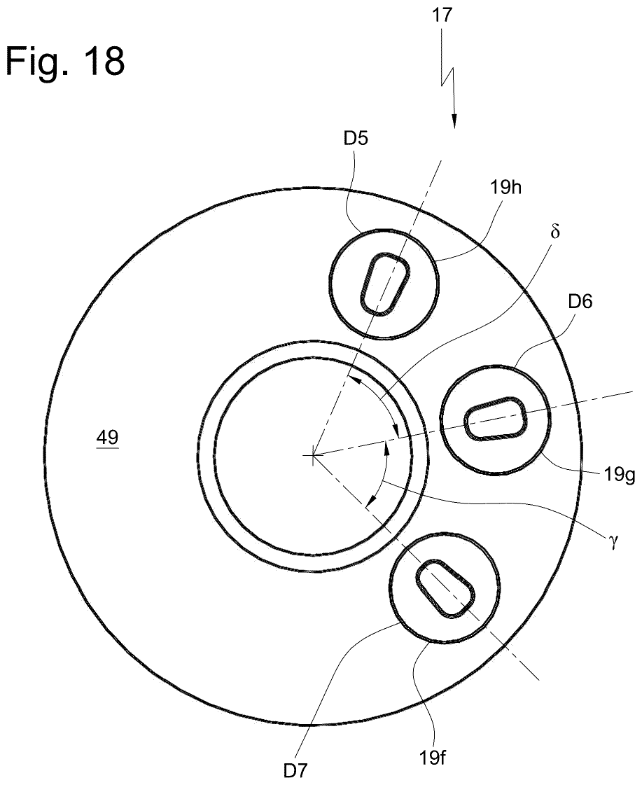

FIG. 18 shows a further embodiment of an actuator of a metering device according to the invention, in an illustration according to FIG. 7, wherein the actuator comprises three through-channels,

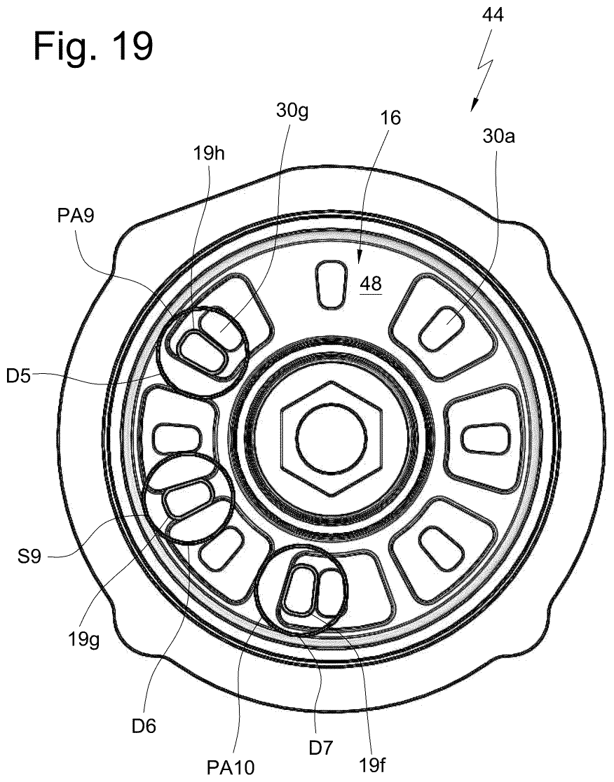

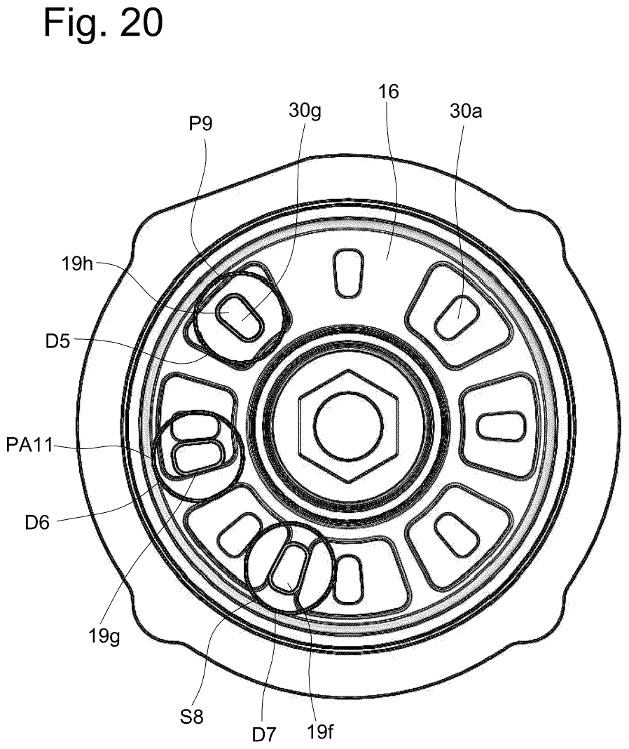

FIG. 19 shows a mixing distributor of a metering device according to the invention, in a view according to FIG. 8, using the actuator according to FIG. 18, having a first position of the actuator,

FIG. 20 shows the mixing distributor unit of FIG. 19 having a changed actuator position,

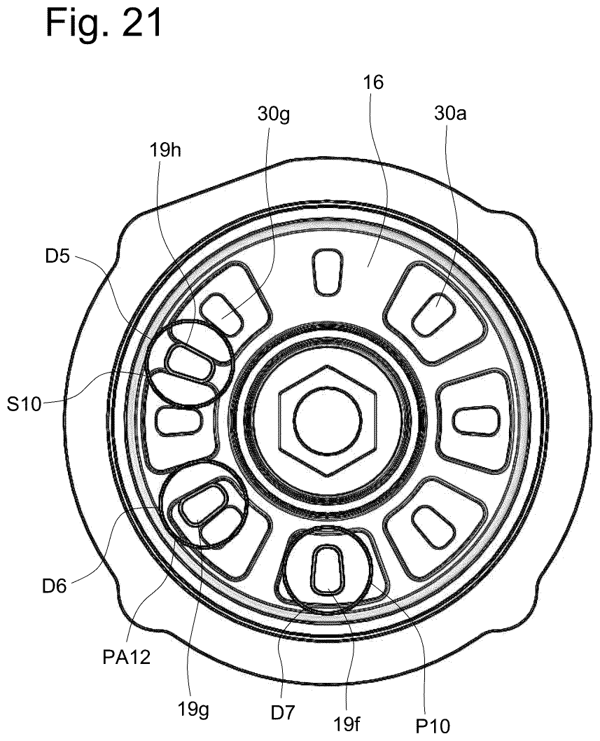

FIG. 21 shows the mixing distributor of FIG. 20 having a further changed actuator position,

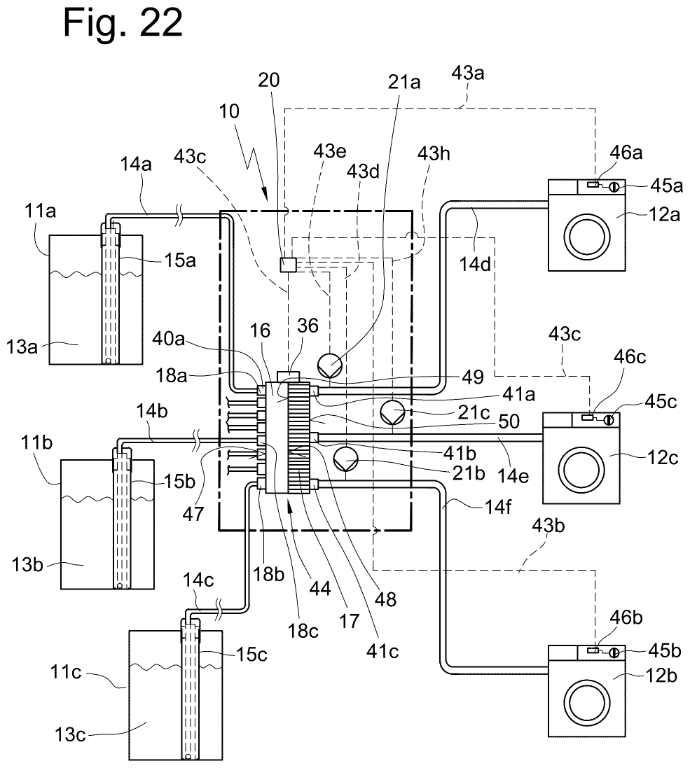

FIG. 22 shows a further embodiment of a metering device according to the invention, in an illustration according to FIG. 17, wherein three target devices are connected to the metering device on the outlet side, and

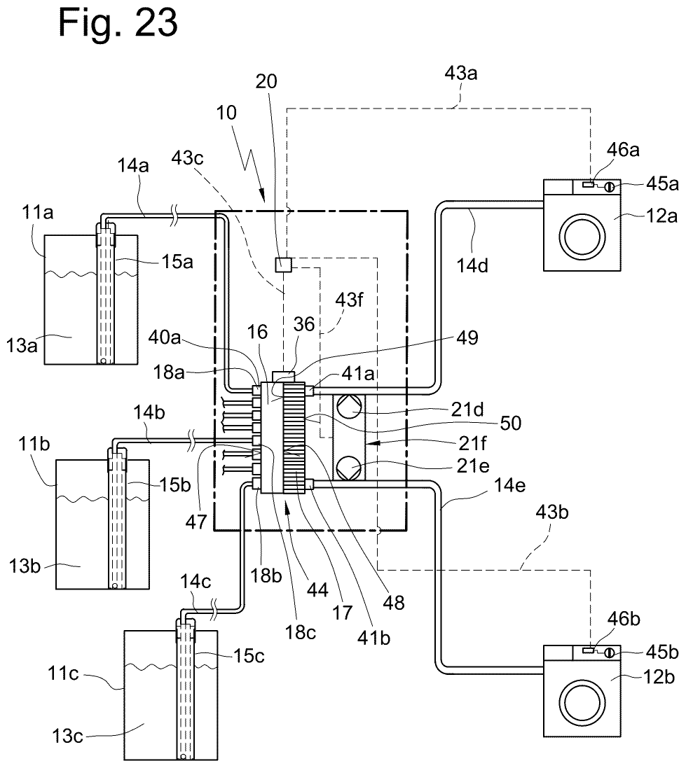

FIG. 23 shows a further embodiment of a metering device according to the invention, in an illustration according to FIG. 17, wherein two pumps are combined to form a pump unit.

The embodiments of the invention will be explained with reference to the following description of the drawings:

Embodiments of the invention are described by way of example in the following description of the figures, also with reference to the drawings.

In this case, for the sake of clarity—also if it relates to different embodiments—identical or comparable parts or elements or regions are denoted by the same reference signs, sometimes with lowercase letters added.

Features which are described only with reference to one embodiment can also be provided, in the context of the invention, in any other embodiment of the invention. Embodiments amended in this way are also covered by the invention, even if they are not shown in the drawings.

All the disclosed features are, individually, essential to the invention. The content of the disclosure of the associated priority documents (transcript of the prior application) and the cited documents and the described devices of the prior art are hereby also included, in their entirety, in the disclosure of the application, also for the purpose of including individual or a plurality of features of said documents in one or more claims of the present application.

An embodiment of a metering device according to the invention is denoted in its entirety, in the drawings, by reference sign 10 and is shown in FIG. 17 in the manner of a block diagram.

The metering device 10 is indicated in FIG. 17 by a dashed frame.

According to FIG. 17, the metering device 10 is connected at the entry-side to containers 11, wherein only three containers 11a, 11b, 11c are shown. In fact, this embodiment of a metering device 10 according to the invention comprises eight entry-side connections 18a, 18b, 18c, 18d, 18e, 18f, 18g, 18h (cf. FIG. 2), of which, however, only the connections 18a, 18b and 18c are denoted in FIG. 17.

The metering device 10 serves for removing media 13a, 13b, 13c from the respective container 11a, 11b, 11c and for conveying the corresponding medium 13a, 13b, 13c to a target device 12a, 12b.

On the output side, the metering device 10 is connected to two target devices 12a, 12b. In the embodiment of FIG. 17, the target devices 12a, 12b are in each case formed by a washing machine.

The containers 11a, 11b, 11c are connected to the metering device via fluid lines 14a, 14b, 14c.

The metering device 10 is connected, on the outlet side, to the target devices 12a, 12b via fluid lines 14d, 14e. For removing the media 13a, 13b, 13c from the respective container 11a, 11 b, 11c, suction lances 15a, 15b, 15c can be provided, as indicated in FIG. 17.

The metering device 10 comprises a mixing distributor 44 comprising a stationary, fixed entry disc 16 and comprising an actuator 17 that is adjustable relative thereto. The actuator 17 can assume different rotational positions relative to the entry disc 16 and, in different rotational positions, can switch different communication paths between the entry-side connections 18a, 18b, 18c and the target devices 12a, 12b.

For this purpose, a plurality of through-channels 19a, 19b are arranged in the actuator 17.

In the embodiment of FIG. 17, two through-channels 19a, 19b are arranged in the actuator 17. These are not shown in FIG. 17.

However, the mixing distributor 44 of the metering device 10 according to FIG. 17 uses, for example, an actuator 17 according to FIGS. 3, 4 and 7, comprising two through-channels 19a, 19b.

The number of through-channels 19a, 19b corresponds in particular, in all the embodiments of the invention, to the number of target devices 12a, 12b connected to the metering device 10.

The mode of operation of the metering device 10 is explained as follows, with reference to FIG. 17:

A controller 20 of the metering device 10 can for example obtain a request signal or a request command via an electrical signal and/or connection line 43a from a controller 46a of the first target device 12a on account of an actuation of the program selection switch 45a of the target device 12a—at a particular point in time, in particular during a washing program—according to which signal or command a particular amount of a particular medium 13a is requested by the first target device 12a.

Thereupon, the controller 20 can activate a drive 36, for example a motor, via a signal line 43, which drive can displace the actuator 17 in a particular rotational range position, in which the corresponding through-channel, for example the first through-channel 19a, is in communicative connection with the container 11a in which the requested medium 13a is located.

Then, the controller 20 of the metering device 10 can activate the first pump 21a for conveying the medium 13a, and thus set said pump into operation.

The pump 21a can for example be a hose pump.

The first pump 21a is arranged downstream of the first through-channel 19a, and, on account of activation by the controller 20, ensures a suction pressure on the outlet side of the through-channel 19a.

As a result, the medium 13a is removed from the container 11a, and conveyed through the fluid lines 14a, 14d to the target device 12a.

The volume to be conveyed is determined from the length of the lifetime of the pump 21a or from the number of rotations of a motor of the hose pump 21a or from another parameter of the pump 21a, taking into account the delivery rate of the pump 21a.

For the event that, subsequently, the target device 12b transmits, by means of the control unit 46b, via the connection line 43b, a request command for the medium 13c to the controller 20, in particular on account of setting of the program selection switch 45b, the actuator 17 can again be displaced by the drive 36 into a changed rotational range position.

A communication path between the container 11c and the second target device 12b is now released. The controller 20 can then activate the pump 21b, in order to convey the medium 13c.

The conveying of the medium 13c to the second target device 12b does not take place through the first through-channel 19a, but rather through the second through-channel 19b.

The second through-channel 19b is firmly associated with the second target device 19b.

Each time medium 13a, 13b, 13c flows through a through-channel 19a, 19b, subsequently rinsing of the corresponding through-channel 19a, 19b with rinsing medium, i.e. for example with water, can take place.

This is described again later.

It is essential for the function and the operation of the metering device 10 that, when a pump, for example the pump 21a, is activated in order to convey medium 13a through the associated first through-channel 19a, said through-channel 19a is configured to be fluid-tight with respect to all the other through-channels.

Operation of the pump 21a thus cannot influence the pressure ratios in the remaining through-channels 19b.

This ensures that only the medium 19a is conveyed, that was requested by the target device 21a.

In order to explain the mode of operation of the metering device 10, initially the structural design of the mixing distributor 44, in particular the entry disc 16 and the actuator 17, is set out with reference to the embodiments of FIG. 1 to 11 in conjunction with FIG. 17.

FIG. 1 is a perspective view of the entry disc 16. The entry disc 16 extends in a substantially circular discoid shape around its central longitudinal axis 42.

On its entry side 47 it comprises, according to FIG. 2, eight entry-side connections 18a, 18b, 18c, 18d, 18e, 18f, 18g, 18h.

FIG. 2 indicates a nozzle 40, merely schematically with dashed lines, for the entry-side connection 18h. Said nozzle is referred to as an entry nozzle and serves for connection of a fluid line, in particular a hose.

All the entry-side connections 18a, 18b, 18c, 18d, 18e, 18f, 18g, 18h can be connected via corresponding connection nozzles (not shown in FIG. 2) and corresponding fluid lines 14a, 14b, 14c, to containers 11a, 11b, 11c.

For this purpose, the nozzles can be inserted into blind hole-like holes on the entry disc 16.

According to FIG. 1, the entry-side connections 18a, 18b, 18c, 18d, 18e, 18f, 18g, 18h extend to the outlet side 48 of the entry disc 16. It can be seen in FIG. 1 that the entry-side connection 18h leads into an open rinsing agent groove 53. The outlet region forms an entry connection 28, which conducts rinsing medium.

The rinsing medium groove 53 comprises a base surface 54.

A total of seven island-like projections, which are approximately trapezoidal in cross-section, project from said base surface 54.

An outlet opening 30a, 30b, 30c, 30d, 30e, 30f, 30g of an entry connection, which is configured as a product medium-conducting connection, is located in the center of each projection.

Within the meaning of the present patent application, a product medium is a chemical or a detergent or a component thereof, which is used in a washing and cleaning process of a washing machine or dishwasher or another target device.

Rinsing medium differs from a product medium. This can be for example water or another suitable medium with which fluid paths can be rinsed.

It can be seen, according to FIG. 6, that the outlet openings 30a, 30b, 30c, 30d, 30e, 30f, 30g are arranged so as to be equidistance from one another.

According thereto, there is in each case a constant distance angle 31 between two outlet openings in each case (for example between the outlet openings 30e and 30f according to FIG. 6). According to the embodiment, said angle is for example approximately 45°, but can also be of a different size.

The outlet openings 30a, 30b, 30c, 30d, 30e, 30f, 30h are in each case arranged so as to have neighboring material regions 32a, 32b on both sides, in the peripheral direction 33 (FIG. 6).

It can be seen from FIG. 6 that a material region 32c has approximately a width 34.

As will be explained below, the material regions 32a, 32b provide blocking surfaces 29a, 29b, by means of which the through-channels 19a, 19b can be closed.

The material regions 32a, 32b, together with the annular surface 55, provide a contact surface 37 of the entry disc 16.

In the embodiment, the actuator 17 is also configured to be substantially discoid in shape. FIGS. 3 and 4 show the actuator 17 in isolation.

The actuator 17 also comprises an entry side 49 and an outlet side 50. In the embodiments of FIGS. 3 and 4, the actuator 17 is surrounded by a gearwheel 51.

The above-mentioned drive 36 (cf. FIG. 17) can for example comprise a pinion and can activate the gearwheel 51 in order to achieve a rotational displacement of the actuator 17.

The actuator 17 and the entry disc 16 are arranged so as to be concentric to one another in the mounted state. FIG. 3 shows an axle structure 52 for this. For details regarding this, and in order to avoid repetitions, reference is also made to the patent application by the applicant, mentioned at the outset.

In the mounted state, the entry side 49 of the actuator 17 is tensioned towards the outlet side 48 of the entry disc 16. Advantageously, the discs 16, 17 are arranged in a manner contacting one another, but so as to allow temporary release.

The entry side 49 of the actuator 17 provides a mating contact surface 39, which rests on the contact surface 37 of the entry disc 16 in the mounted state.

The two surfaces 37, 39 ensure sealing relative to the outside space.

FIG. 3 shows that the actuator 17 comprises a first through-channel 19a and a second through-channel 19b. The through-channel 19a, 19b in each case has a clear width 35.

Advantageously, all the through-channels 19a, 19b are provided with the same clear width 35.

It should be noted that the above-described width 34 of the material region 32a, which makes out the blocking surface 29, is at least slightly larger than the clear width 35 of the through-channel 19a.

FIG. 7 is a front view of the entry side 49 of the actuator 17, and illustrates that the two through-channels 19a, 19b can be arranged at an angle α of approximately 112.5° relative to one another.

Other angles are also admissible.

FIG. 3 to 5 make it clear that each through-channel 19a, 19b is associated with its own outlet nozzle 49a, 49b.

As FIG. 17 shows, each through-channel 19a, 19b is connected to the corresponding target device 12a, 12b via a corresponding fluid line 14d, 14e.

FIG. 7 is a view showing the entry side 49 of the actuator 17. FIG. 8 is a view of the outlet side 48 of the entry disc 17 together with a projection of the position of the through-channels of the actuator 17.

This image results when, in an illustration according to FIG. 6, the entry side 49 of the actuator 17 of FIG. 7 is placed on the outlet side 48 of the entry disc 16. In other words, the actuator 17 is placed on the entry disc 16 in such a way that the surfaces 37 and 39 contact one another.

In this case, FIG. 8 illustrates, in relation to the entry disc 16, the position of the two through-channels 19a, 19b, in order to illustrate the rotational position of the actuator 17. The positions of the two through-channels 19a, 19b are denoted in FIG. 8 on the basis of the two circles D1 and D2.

The first through-channel 19a is located in the center of the position circle D1; the second through-channel 19b is located in the center of the position circle D2.

The following FIG. 9 to 11 in each case show the positions of the through-channel 19a, 19b in different rotational peripheral positions of the actuator 17.

According to FIG. 8, the second through-channel 19b assumes a first product position P1.

The through-channel 19b is in superimposition with the corresponding outlet opening 30g. Thus, in the position of the actuator 17 according to FIG. 8, the second through-channel 19b is in communicative connection with the entry-side connection 18g.

According to FIG. 8, the first through-channel 19a assumes a first rinsing position S1. According to FIG. 8, the first through-channel 19a is located exactly centrally between two outlet openings 30d and 30e. The first through-channel 19a is thus in communicative connection with the rinsing medium 53.

It is therefore in a rinsing position S1, in which the first pump 21a, associated with the first through-channel 19a, could convey rinsing medium when the pump 21a is operated.

In this position according to FIG. 8 the pump 21b associated with the second through-channel 19b can be activated and convey the medium present at the outlet opening 30fg.

Upon activation of the second pump 21b, the through-channel 19b is not in communicative connection with the through-channel 19a.

This is clear on the basis of the position of the actuator 17 according to FIG. 8:

The second through-channel 19b communicates only with the outlet opening 30g.

The first through-channel 19a, which communicates only with the rinsing medium groove 53, is separated therefrom.

Owing to the contacting of contact surfaces 37 of the entry disc 16 and of the mating contact surface 39 on the entry side 49 of the actuator 17, the outlet opening of the through-channel 19b is sealed relative to the outlet opening 30g.

In the event that the first pump 21a is activated, which is associated with the through-channel 19a, on account of the through-channel 19a located in a rinsing position S1, the pump 21a can convey rinsing medium and rinse the first through-channel 19a.

FIG. 9 shows a rotational position of the actuator 17 relative to the entry disc 16 that is changed compared with FIG. 8. Here, the actuator 17 has been rotated about an angle of approximately 22.5°, in the anti-clockwise direction, proceeding from the position according to FIG. 8.

Here, the second through-channel 19b assumes a rinsing position S2.

In contrast, the first through-channel 19a has been brought into communicative connection with the outlet opening 30d and is in a second product position P2.

FIG. 10 shows a changed, third relative position of the actuator 17 relative to the entry disc 16.

Here, the first through-channel 19a and the second through-channel 19b are each in a parked position PA1, PA2. In this position of the actuator, both through-channels 19a, 19b are in each case positioned on a blocking surface 29b, 29c, which is provided by a material region 32a, 32b of the entry disc 16.

In this position, the two through-channels 19a, 19b are closed by the respective blocking surface.

FIG. 11 shows a further position of the actuator 17 relative to the entry disc 16.

Here, the first through-channel 19a is in a parked position PA4, and the second through-channel 19b is in a parked position PA3.

In the embodiment of FIG. 8 to 11, it is ensured that whenever one of the two through-channels 19b is on a product position P1, the respective other through-channel 19a is always on a rinsing position S1.

This follows for example from FIGS. 8 and 9.

In addition, it is clear in this embodiment that when one of the two through-channels 19a is located in a parked position PA2, the respective other through-channel 19a is also located in a parked position PA1.

It is thus ensured, by the geometry and the positioning of the through-channels 19a, 19b in the actuator 17 and by the geometry and positioning of the outlet openings 30a, 30b, 30c, 30d, 30e, 30f, 30g on the entry disc 16, that the switched fluid communication paths are always separated from one another.

This principle also applies for the further embodiment of FIG. 12 to 16, described below FIG. 12 shows another embodiment of an actuator 17, wherein again the entry side 49 is shown.

The embodiment of FIG. 12 again shows a first through-channel 19d and a second through-channel 19e. Here, a different angle β between the through-channels is provided compared with the embodiment described above. According to FIG. 12, the angle β is approximately 66°.

FIG. 13 shows, in a manner comparable to the illustration of FIG. 8, the entry disc 16 when viewing the outlet side 48, illustrating the positions of the two through-channels 19d, 19e of the actuator 17 of FIG. 12 in a first rotational position of the actuator 17 relative to the entry disc 16.

In FIG. 13, the position of the through-channel 19e is denoted by D3, and the position of the through-channel 19d is denoted by D4.

According to FIG. 13 the through-channel 19e is located in a rinsing position S3.

The through-channel 19d is located in a product position P3.

Proceeding from the illustration of FIG. 13, FIG. 14 shows an actuator 17 having a changed position relative to the entry disc 16, wherein the actuator 17 is rotated relative to the entry disc 16 approximately about an angle of 22.5° in the clockwise direction.

Here, the through-channel 19e is located in a product position P5, and the through-channel 19d is located here in a rinsing position S5.

FIG. 15 shows the embodiment of FIG. 13, in which the actuator 17 has been rotated approximately about 56+θ, in the anti-clockwise direction, relative to the entry disc 16, proceeding from FIG. 13.

According to FIG. 15 the actuator 17 is located in a position in which the through-channel 19e assumes a parked position PA5 and the through-channel 19d assumes a parked position PA6.

FIG. 16 shows a further relative position of the actuator 17 relative to the entry disc 16 of the same embodiment:

Here, proceeding from the illustration of FIG. 15, the actuator has been rotated further, in the anti-clockwise direction, relative to the entry disc 16.

According to FIG. 16, the through-channel 19e assumes a parked position PA7 and the through-channel 19d assumes a parked position PA8.

A further embodiment, in which three through-channels 19f, 19g, 19h are arranged in the actuator 17, with an unchanged entry disc 16, is shown in FIG. 18 to 21.

It can be seen from FIG. 18—which is an illustration of an actuator 17 analogous to the illustration of FIG. 7—that the through-channels 19g, 19f are spaced apart from one another at an angle β, and the through-channels 19h, 19g are spaced apart from one another at an angle δ.

In the embodiment of FIG. 18, the angles γ and δ are identical and are in each cases 60°. Other angles are also possible. FIG. 19 shows, in an illustration analogous to the illustration of FIG. 8. the entry disc 16 that is left unchanged, and in addition the position D5 of the through-channel 19h, the position D6 of the through-channel 19g, and the position D7 of the through-channel 19f of the actuator 17.

In the position of the actuator 17 relative to the entry disc 16 according to FIG. 19, the through-channel 19h assumes a parked position PA9, the through-channel 19g assumes a rinsing position S9, and the through-channel 19f assumes a parked position PA10.

FIG. 20 shows the embodiment of FIG. 19, in which the actuator 17 has been rotated about only a few degrees, in the clockwise direction, relative to the entry disc 16, with respect to the position of FIG. 19.

According to the position of the actuator 17 according to FIG. 20, the through-channel 19h assumes a product position P9, the through-channel 19g assumes a parked position PA11, and the through-channel 19f assumes a rinsing position S8.

FIG. 21 shows the embodiment of FIG. 19, wherein the actuator 17 has been rotated about only a few degrees, in the anti-clockwise direction, relative to the entry disc 16.

According to FIG. 21, the through-channel 19h assumes a rinsing position S10, the through-channel 19g assumes a parked position PA12, and the through-channel 19f assumes a product position P10.

In this case, it is notable that whenever one of the through-channels 19f, 19g, 19h assumes a product position P9 or P10, in each case one of the two remaining channels assumes a parked position PA10, PA11 and the respective other of the two through-channels assumes a rinsing position S10, S9, S8.

It is furthermore notable in this embodiment that the spacings of the through-channels 19f, 19g, 19h, their positioning, and the geometry and positioning of the outlet openings 30a, 30b, 30c, 30d, 30e, 30f is such that, when one of the through-channels 19f, 19g, 19h assumes a rinsing position (for example the rinsing position S9, S8 or S10), neither of the two remaining through-channels assumes a rinsing position, but rather, instead, either both remaining through-channels each assume a parked position (cf. the illustration of FIG. 19), or in each case one of the two remaining through-channels assumes a product position and in each case the other of the two remaining through-channels assumes a parked position (cf. FIGS. 20 and 21).

As a result, a reliable separation of the communication paths in each switched position of the actuator 17 relative to the entry disc 16 is ensured.

The embodiment of FIG. 22 shows a metering device 10 in an illustration analogous to the illustration of FIG. 17.

In the embodiment of FIG. 22, three target devices 12a, 12b, 12c are connected on the outlet side.

Accordingly, the mixing distributor 44 comprises three outlet nozzles 41a, 41b, 41c.

The embodiment of FIG. 22 can comprise an actuator 17 having three through-channels 19g, 19f, 19h, as is shown in FIG. 18 to 21.

FIG. 22 illustrates that each of the three through-channels 19f, 19g, 19h or outlet nozzles 41a, 41b, 41c is in each case associated with its own pump 21a, 21b, 21c. Each of the pumps 21a, 21b, 21c is connected to the controller of the metering device 10 via its own connection line 43d, 43e, 43h.

On the entry side, again eight different media, i.e. in particular seven product media and one rinsing medium, can be connected to the metering device 10.

The different media 13 can in particular be supplied to the plurality of target devices 12a, 12b, 12c successively, under certain conditions also simultaneously.

The embodiment of FIG. 23 is similar to the embodiment of FIG. 22. Here, only two target devices 12a, 12b are connected to the metering device 10, on the outlet side.

Again, each of the two through-channels 19a, 19b, or each of the two nozzles 41a, 41b at the outlet of the actuator 17 is associated with one pump 21d, 21e in each case.

Here, however, the two pumps 21d, 21e are assembled to form a pump unit 21f. This is connected centrally to the controller 20 of the metering device 10 via a single signal and connection line 43f.

The pump unit 21 can for example be a hose pump, which comprise only a motor drive, possibly also only a rotor.

Here it can be provided, for example, that only the fluid line 14d is activated, in the sense of conveying, by a rotation of the motor in a first direction, and only the conveying line 14e in the case of an actuation of the pump motor in the opposite direction of rotation.

A pump unit 21f of this kind can thus comprise two partial pumps 21d, 21 e, or also more, in particular also three partial pumps 21d, 21 e.

The partial pumps 21a, 21b can be coupled to a motorized drive of the pump unit 21f by means of a transmission.

What is decisive is that in each case it is possible to achieve a selectable activation of the pump unit 21f with respect to different fluid lines 14d, 14e by the pump unit 21f, such that the pump unit 21f can fulfil the function of a plurality of individual pumps 21d, 21e.

All the embodiments of the metering device according to the invention, and all the embodiments of the method according to the invention, have in common the fact that it is advantageously provided that each time, after one of the pumps 21a, 21b, 21c, 21d, 21 e, 21f, 21g has conveyed a product medium through a through-channel 19a, 19b, 19c, 19d, 19e, 19f, said through-channel is subsequently rinsed with rinsing medium. The controller 20 of the metering device thus ensures that, after each instance of conveying of a product medium through a through-channel 19a, said through-channel 19a is subsequently moved into a rinsing position, and the pump associated with the rinsing channel is activated, in order to convey rinsing agent.

The rinsing of the line paths prevents different products, which may not come into contact with one another, from coming into contact.

The controller 20 of the metering device 10 actuates the actuator 17 for example in such a way that, each time a through-channel, for example the through-channel 19a, reaches a product position, for example P1, and the pump 21a associated with the through-channel 19a has conveyed a product medium, after completion of the conveying of said medium, or in any case before another product medium is conveyed through said through-channel 19a, said through-channel 19a approaches a rinsing position, for example S1, and the pump 21a is then activated in order to convey the rinsing medium.

In all the embodiments of the metering device 10 according to the invention, it can be provided that the actuator 17 is rotatable relative to the entry disc 16 only in a manner having limited rotational range.

For example, a maximum permissible twist angle of the actuator 17 relative to the entry disc 16 of 355° can be provided. Said rotational stop can be achieved by mechanical elements, but also via an electronic controller. It should be noted that the rotational position of the actuator 17 relative to the entry disc 16 can be acquired for example by means of a rotational angle sensor.

With the aid of said rotational angle sensor or another position sensor, the controller 20 can also obtain information relating to whether the actuator 17 has assumed a particular product position (for example P1) or a particular parked position (for example PA1), or a particular rinsing position (for example S1).

Only when there is confirmation about the fact that a particular product position or rinsing position of a particular through-channel 19a is received can the controller 20 release the pump 21a connected to the through-channel 19a and activate said pump in the sense of medium conveying.

In the case of the metering device 10 according to the invention, it can be provided that one of the plurality of through-channels 19a, 19b cannot approach all of the product positions P1, P2, P3, P4, P5, P6, P7, P8, P9, P10, P11 provided by the entry disc 16, but rather only some of these product positions.

It can thus be provided, for example in the embodiment of FIG. 8 to 11, that each of the two through-channels 19a, 19b can approach just four product positions.

In the case of the embodiment of FIG. 12 to 16, it can be provided that each of the two through-channels 19d, 19e can in each case approach exactly three product positions.

In the case of the embodiment of FIG. 18 to 21, it can be provided that each of the two outer through-channels 19h, 19f can in each case approach five product positions.

The selection of the number of product positions P1, P2 that can be approached is at the discretion of a person skilled in the art.

In the embodiments of FIGS. 1 to 17 and 23, in which the actuator 17 comprises two through-channels in each case, it can be provided that, in addition to a rinsing medium, up to seven different product media can be connected to the metering device, at the entry side.

Then, for example the product media P1, P2, P3, P4 can be supplied vi the first through-channel 19a only to the first target device 12a, and the product media P5, P6, P7 can be supplied via the second through-channel 19a only to the second target device 12b.

However, the invention also covers the situation when for example only four different product media are connected at the entry side of the metering device 10, and therefore only three different product media are connected at six of the seven entry-side connections 18a, 18b, 18c, 18d, 18e, 18f, 18g, such that the same product medium is connected at two of said entry-side connections in each case.

In the case of such a division, four different product media can be supplied to two connected target devices.

In the embodiment of FIG. 18 to 21, for example three different product media can be supplied to all three connected target devices.

The way in which the supply to the target devices is carried out, with what chemicals, can be determined by a person skilled in the art.

It is essential for the operation of the metering device 10 that the controller 20 of the metering device 10 knows which product medium 13a, 13b is present at which of the entry-side connections 18a, 18b, 18c, 18d, 18e, 18f, 18g, 18h.

In order to prevent repetitions, reference is made to the older patent applications of the prior art, by the applicant, mentioned at the outset, which specify devices and methods which achieve this.

In all the embodiments of the metering device 10 according to the invention, the entry disc 16 is configured identically. In all the embodiments of the entry disc 16, the entry connection 18h is configured as a rinsing medium connection, which leads, on the outlet side 48 of the entry disc 16, into a single groove 53 for the rinsing medium.

As can be best seen in FIG. 1 in conjunction with FIG. 8, said rinsing agent groove 53 surrounds all the island-like projections, formed by the material regions 32a, 32b, in the peripheral direction.

This geometry ensures that each product position P1, P2 is enclosed on both sides, in the peripheral direction 33, both by a parked position PA, and, further outside, also by a rinsing position S in each case.

Thus, the adjustment paths of the actuator 17 relative to the entry disc 16 are kept very short, in order to ensure that, after conveying of a product medium, the same through-channel 19a brings about conveying of a rinsing medium.

Embodiments of the invention that are not shown provide, on the outlet side 48 of the entry disc 16, not only, as shown in the figures, a single groove 53 for rinsing medium, but rather provide a plurality of channels or grooves for rinsing medium, wherein these channels are delimited and sealed relative to one another.

This allows for simultaneous operation of a plurality of pumps 21a, 21b in a position of the actuator 17, in which a plurality of through-channels 19a, 19b each assume a rinsing position S. In this way, it can be ensured that the operation of one of the pumps for conveying rinsing medium in one of the through-channels does not impair for example simultaneous or subsequent rinsing medium conveying in another through-channel.

The invention furthermore includes the situation where non-return valves or other blocking devices are provided, which prevent a return flow of a medium through a through-channel.

For this purpose, for example flaps or other blocking means can be provided.

In all the embodiments of the invention, all the outlet openings 30a, 30b, 30c, 30d, 30f, 30g, 30h for the rinsing medium and for the product media are located on a common radius, based on the central longitudinal axis 42 of the entry disc 16.

In the same way, all the through-channels 19a, 19b are located on the same radius, based on a center of the actuator 17.

In the case of further embodiments not shown in the drawings, different outlet openings and/or different through-channels can also be located on different radii.

In numerous embodiments of the metering device 10 according to the invention, and in numerous embodiments of the method according to the invention, it is provided that the pumps 21a, 21b are not operated simultaneously, but rather always only successively.

This allows for a particularly reliable mode of operation.

If firstly a medium is to be supplied to a target device, the controller activates the actuator 17, wherein the drive 36 brings the actuator 17 into the desired rotational position, such that the through-channel (for example 19a) assumes a product position P (for example P1).

The pump 21a is then activated for conveying the product medium 13a. In the following, the through-channel 19a is displaced by the controller 20 via the drive 36 for the actuator 17 into a rinsing position, and then the pump 21a is again activated in order to rinse the through-channel.

Only then is the second through-channel 19b displaced into a product position P (for example P2), in order to convey a product medium.

However, other embodiments of the invention also cover the situation when a plurality of through-channels 19a, 19b, which comprise separate communication paths, are acted on simultaneously by a plurality of pumps 21a, 21 b.

1-30. (canceled)

31. A metering device for metering and supplying media via fluid lines to a plurality of target devices, wherein the metering device comprises: an entry disc having a plurality of entry-side connections that are each connectable to a container; an actuator that is displaceable relative to the entry disc and which comprises a plurality of through-channels, wherein each through-channel is connectable to one of the target devices, wherein, due to a displacement of the actuator relative to the entry disc, at least one of the through-channels is brought into communicative connection with one of the connections; a plurality of pumps that are connectable by a controller of the metering device and are configured for feeding medium from the container to the target device, and wherein each through-channel is associated with one of the plurality of pumps that is arranged downstream of the through-channel.

32. The metering device according to claim 31, wherein the metering device is configured to permit operation of one of the pumps only when the actuator assumes a position in which a communicative connection of the through-channel associated with said pump to any other through-channel is blocked.

33. The metering device according to claim 31, wherein two pumps for conveying media are operated simultaneously by the metering device

34. The metering device according to claim 31, wherein a flow passes through the plurality of through-channels in a common direction.

35. The metering device according to claim 31, wherein the plurality of through-channels are configured to be straight.

36. The metering device according to claim 31, wherein each of the through-channels can assume at least one product position, in which the through-channel communicates with a product medium-guiding entry connection.

37. The metering device according to claim 31, wherein each of the through-channels can assume at least one rinsing position, in which the through-channel communicates with a rinsing medium-guiding entry connection.

38. The metering device according to claim 31, wherein each of the through-channels can assume at least one parked position, in which the through-channel communicates neither with a rinsing medium-guiding entry connection nor with a product medium-guiding entry connection.

39. The metering device according to claim 38, wherein the through-channel assuming a parked position is closed by an entry disc-side blocking surface.

40. The metering device according to claim 36, wherein an arrangement of the through-channels relative to one another in the actuator and an arrangement of the entry-side connections on the entry disc is such that in each position of the actuator relative to the entry disc in each case only at most one of the through-channels assumes a product position.

41. The metering device according to claim 36, wherein an arrangement of the through-channels relative to one another in the actuator and an arrangement of the entry-side connections in the entry disc is such that in at least one position of the actuator relative to the entry disc two of the through-channels assume a product position.

42. The metering device according to claim 31, wherein at least one of the entry-side connections is configured as a rinsing medium connection.

43. The metering device according to claim 31, wherein the controller of the metering device performs a metering process after receiving a request signal from at least one of the target devices, and performs a removal of a predetermined volume of medium from the container and conveys said predetermined volume towards a target device, with the aid of at least one of the pumps.

44. The metering device according to claim 31, wherein in each case one entry-side connection is connected to one container.

45. The metering device according to claim 31, wherein in a plurality of containers is provided, which are filled with different media.

46. The metering device according to claim 31, wherein the entry-side connections comprise seven product medium connections and one rinsing medium connection.

47. The metering device according to claim 31, wherein the entry-side connections comprise outlet openings on an outlet side of the entry disc.

48. The metering device according to claim 47, wherein the outlet openings are arranged so as to be equidistant from one another.

49. A method for metering and supplying media via fluid lines to a plurality of target devices, comprising the steps of:
a) providing a metering device comprising an entry disc having a plurality of entry-side connections and comprising an actuator that is displaceable relative to the entry disc and which comprises a plurality of through-channels, wherein a pump is arranged downstream of each through-channel;
b) connecting the entry-side connections to containers that are filled with media;
c) connecting each through-channel to a target device;
d) transmitting a request for a particular amount of a medium from a first target device to a controller of the metering device;
e) displacing the actuator relative to the entry disc so that a first of the through-channels associated with the first target device is brought into communicative connection with the connection at which the requested medium is present;
f) activating the pump, which is associated with the first through-channel, for feeding the requested medium from the container to the first target device.

50. The method according to claim 49, further comprising the steps of:
g) displacing the actuator relative to the entry disc so that the first through-channel associated with the first target device is brought into communicative connection with the connection at which a rinsing medium is present; and
h) activating the first pump for removing rinsing medium and for conveying the rinsing medium for rinsing the first through-channel.
